(19) United States
(12) Patent Application Publication
(10) Pub. No.: US 2005/0267946 A1
(43) Pub. Date: Dec. 1, 2005

(54) Method, media renderer and media source for controlling content over network

(75) Inventors: Cheol-hong An, Suwon-si (KR); In-hwan Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/120,178

(22) Filed: May 3, 2005

(30) Foreign Application Priority Data
May 3, 2004 (KR) 10-2004-0031060

(51) Int. Cl. G06F 15/16

(52) U.S. Cl. 709/217

(57) ABSTRACT

A method, a media renderer device and a media source device for providing content over a network, and a message structure for controlling a real-time transport protocol (RTP) are provided. The method includes transferring a hypertext transfer protocol (HTTP) control command generated so that content is provided from a media server providing content using a RTP. The HTTP control command can use an HTTP POST command or an HTTP PUT command. When transferring AV content using a RTP, the content is controlled using an existing HTTP not a Real-Time Streaming Protocol (RTSP). Accordingly, a RTP can be more easily supported.

### BACKGROUND OF THE INVENTION

This application claims the benefit of Korean Patent Application No. 2004-31060, filed on May 3, 2002, in the Korean Intellectual Property Office, the disclosure of which is incorporated herein in its entirety by reference.

1. Field of the Invention

The present invention relates to a home network, and more particularly, to a method for controlling content over a network, a media renderer device, a media source device and a message structure for controlling a real-time transport protocol (RTP).

2. Description of the Related Art

With the evolution of the digital age, there are more opportunities to connect the digital products around us. A number of digital products, for example, digital video disc (DVD) players, cable set top boxes (STBs), digital video cassette recorders (DVCRs), digital televisions (DTVs), and personal computers (PCs), are connected in a single network. These various products are connected over a network and a home network standard for controlling the digital products is being established by the Digital Home Working Group (DHWG).

Recently, a multimedia environment in a home network can be classified mainly into three worlds, or domains. Those include a PC Internet world, a mobile world, and a Consumer Electronics (CE) broadcast world.

FIG. 1 is a view for explaining a conventional home network environment according to the definition by the DHWG.

The PC Internet world 100 includes a PC 101, a game console 102, a printer 103, a digital imaging device 104, a digital music device 105, a wireless monitor 106, and others.

The mobile world 110 includes a laptop computer 111, a multimedia mobile phone 112, a PDA 113, and others. They provide users with freedom of movement into and out of the home network.

The CE broadcast world 120 includes a TV monitor 121, traditional consumer electronics 122 such as a personal video recorder (PVR), a tuner, a set top box (STB), and a stereo set 123, and others.

Consumers want to connect devices from the three domains together in home. Therefore, a research on the home network is required to attain interoperability between these digital worlds.

The digital home consists of a network of CE, mobile, and PC devices that cooperate with each other for simple, transparent and incessant interoperability. These networks are based on Internet Protocol (IP) networking protocols and Universal Plug and Play (UPnP) technology.

Media management and control based on UPnP audio/video AV technology enables devices and applications to identify, manage, and distribute media content in the home network, and to transfer the media content to mobile devices.

UPnP is a peer-to-peer network architecture that can be used to connect, for example, intelligent appliances, wireless devices, and PCs. It is designed to provide an easy-to-use, flexible and standard-based connectivity to a small network in, for example, a home or a small business. The UPnP AV architecture defines the general interaction between UPnP devices and associated UPnP control points. The UPnP architecture allows devices to support content in any format and over any transport protocol. UPnP devices include TVs, video cassette recorders (VCRs), compact disc (CD) players, digital video disc (DVD) players, set top boxes, stereo systems, MP3 players, still image cameras, camcorders, and PCs. Further, the AV architecture allows the devices to support content in different formats such as MPEG2, MPEG4, JPEG, MP3, BMP, and Windows media architecture (WMA), and other transport protocols such as IEEE-1394, HTTP GET, RTP, HTTP PUT/POST, and TCP/IP.

Most UPnP AV scenarios involve transmission of content such as movies, music, and pictures, from one device to another. An AV control point interacts with two or more UPnP devices which functions as a “source” and a “sink”. While the control point regulates and synchronizes the operations of the two devices, the devices interoperate with each other using a non-UPnP (out-of-band) communication protocol. The control point uses UPnP to initialize and configure the two devices, so that the desired content can be transferred from one device to the other. However, since the content is sent using an out-of-band transport protocol, the control point is not directly involved in substantial content transmission.

As described above, the UPnP AV specification classifies logical devices into two types in the home network—media servers and media renderers.

The media servers have content that users want to render on the media renderer. The users interact with a control point user interface UI to search and select content contained in the media server, and select a desired media renderer. The media servers may include a plurality of content or access the content. The media servers access the content and transfer the content to other devices over a network by using a predetermined transport protocol. The content is transferred using a transport protocol and a data format which the media servers and the media renderers can understand. The media servers may include VCRs, CD/DVD players, cameras, camcorders, PCs, set top boxes, satellite receivers, audio tape players, and so on.

The media renderers receive content from the media servers over a network. The media renderers may include TVs, stereo systems, MP3 players, and electronic picture frames.

The control point regulates and manages operations of the media server and the media renderer, as designated by a user, to perform operations such as playing what the user wants. Further, the control point provides a UT so that the user can control the operations of the devices. The control point may be a TV or a wireless PDA device having a general remote controller. In addition, when requested, the control point may control the flow of content by invoking various AV transfer actions, such as stop, pause, fast forward (FF), rewind (REW), and skip.

FIG. 2 is a diagram of a conventional UPnP system configuration.

Referring to FIG. 2, the UPnP system includes a control point 200, a source device 210, and a sink device 220.

The control point 200 controls the source device 210 and the sink device 220 and detects the states thereof using a simple object access protocol (SOAP) command.

The source device 210, which functions as a media server, provides AV content to the sink device 220, and receives commands from the control point 200 to provide necessary information for the sink device 220. Also, the source device 210 receives a real-time streaming protocol (RTSP) command from the sink device 220, and then transfers data over a real-time transport protocol (RTP).

The sink device 220 which functions as a media renderer, consumes AV content, and receives commands from the control point 200 to perform necessary operations. For example, after receiving a play command from the control point 200, the sink device performs setup and play commands by using an RTSP protocol. The setup command of the RTSP specifies a transfer mechanism to be used for a streaming system. PLAY is a method of ordering a server to start data transmission through the mechanism specified by SETUP.

RTSP (Real-Time Streaming Protocol) will be briefly explained below.

Almost all of Internet multimedia users want to control continuous playback of media by stopping playback, seeking a next or previous clip, fast forwarding an image, or rewinding an image. Such operations are similar to the operations performed by a video cassette recorder and a compact disc (CD) player. To enable the users to control the playback, a media player and a server need a protocol swapping play control information, and such protocol is a real-time streaming protocol (RTSP) defined in request for comments (RFC) 2326. RTSP is a so-called out-of-band protocol, and allows an RTSP message to be sent using either TCP or UDP. RTSP is a protocol that enables media players to control transmission of a media stream. RTSP dose not define how audio and video is encapsulated into packets. However, Real-Time Transport Protocol (RTP) or any individual protocol can define how streaming media is encapsulated.

RTSP differs basically from the hyper text transfer protocol HTTP in that data transmission is performed by an out-of-band system using different protocols. HTTP is an asymmetric protocol where a client issues requests and a server responds to the client's requests. In RTSP, both a media client and a media server can issue requests. Almost all of real-time media may use RTP as a transport protocol, but RTSP is not constrained to RTP.

RTP (Real-Time Transport Protocol) will be briefly explained below.

Before transferring A/V data units to a transport layer on the transmit side of a multimedia application, sequence numbers and timestamps are attached to the A/V data units. Since in almost all multimedia networking applications, sequence numbers and the timestamps are used, it is convenient to have fields for audio/video data and a standardized packet structure including sequence numbers and timestamps, and such standard is RTP defined in RFC 1889. In general, RTP is executed under a user datagram protocol (UDP). The A/V data units generated by the transmit side of the multimedia application are encapsulated into RTP packets. The RTP packets are re-encapsulated into UDP segments.

The control point 200 executes commands to obtain content information from the source device 210, and provides the sink device 220 with the protocol information and content uniform resource locator URL to be sent together with a play command to play necessary content. If the protocol to be transmitted is HTTP, the sink device 220 obtains data from the source device 210 by using an HTTP Get method, or if the protocol to be transmitted is RTP, the sink device 220 executes setup and play commands for the source device 210 by using an RTSP command and the source device 210 transfers the content data specified in the commands by using RTP.

FIG. 3 is a diagram illustrating a typical HTTP request message structure.

An HTTP message includes a request message to be transferred to a server from a client and a response message to be transferred to the client from the server.

A first line of the request message is a request line containing a method 311 to be applied to a resource, a resource identifier 312, and a protocol version 313. The method includes GET, HEAD, POST, PUT, and others.

A request header line 320 is a field for the client to request and send the additional information of it to the server.

An entity 330 includes an entity header field 331 and an entity body field 332. The entity header field defines meta information about the entity body, otherwise, if the entity body does not exist, defines meta information about a resource identified by a request.

As known from the above operations, when data is transmitted using RTP, the other device should be controlled using the RTSP protocol. However, when the device already has an HTTP protocol available to transfer both commands and data, it may be preferable to use the existing HTTP rather than to use another protocol. Specifically, it would be better than using RTSP to transfer commands for receiving data using RTP.

### SUMMARY OF THE INVENTION

The present invention provides a method, a media renderer device and a media source device for controlling content over a network, and a message structure for controlling a real-time transport protocol (RTP), wherein the content can be transferred using the RTP, not an RTSP, on a home network.

According to an aspect of the present invention, there is provided a method of controlling content over a network, the method comprising: transferring a hypertext transfer protocol (HTTP) control command made so that content is provided from a media server using a real-time transport protocol (RTP); and receiving the content from the media server through the RTP.

The HTTP control command may include an HTTP POST command or an HTTP PUT command.

The HTTP control command may include information about content transport.

The content transport information may include destination address information and port information for receiving content. Further, the content transport information may provide destination address information and port information for receiving content as information managing a session.

The HTTP control command may include a control operation command with respect to the content.

According to another aspect of the present invention, there is provided a method of controlling content over a network, the method comprising: receiving an HTTP control command so that content is provided from a media renderer performing rendering of content over a network; and sending the content over a network by using an RTP in response to receipt of the HTTP control command.

The HTTP control command may include an HTTP POST command or an HTTP PUT command.

The HTTP control command may include information about content transport.

The content transport information may include destination address information and port information for sending content, and in the operation of sending the content, the content may be sent to a destination indicated by the destination address information and the port information.

According to still another aspect of the present invention, there is provided a media renderer device for controlling content over a network, the media renderer device comprising an HTTP control command generating unit generating an HTTP control command by which content is provided from a media server providing content using an RTP.

The HTTP control command generating unit may generate the HTTP control command by using an HTTP POST command or an HTTP PUT command.

According to yet another aspect of the present invention, there is provided a media server device for controlling content over a network, the media server device comprising: an HTTP control command interpreter interpreting an HTTP control command generated so that content is provided from a media renderer performing rendering of content over a network using an RTP; and a content transferring unit transferring the content over a network by using an RTP on the basis of the interpreted result.

The content transport information may include destination address information and port information for transferring content, and the content transferring unit transfers the content to a destination indicated by the destination address information and the port information.

The HTTP control command may include control operation information with respect to the content, and the HTTP control command interpreter controls the content based on the control operation information.

According to a further aspect of the present invention, there is provided a message structure for controlling the RTP of content on a network, in which the message is based on a HTTP request message, the message structure comprising: transport protocol information for transferring content; address information for receiving content; and information about a operation control with respect to content.

The HTTP request message may use an HTTP POST message or an HTTP PUT message.

The present invention suggests a method for transferring a control command by using an existing HTTP, as a control method, in the case of transmitting AV data from the existing devices using an RTP. In particular, since the Digital Home Working Group (DHWG) provides a function of transferring AV data by using HTTP, it is considered that if RTP transport is added to the DHWG, controlling content over a network can be easily implemented by providing only a control command using an existing HTTP without a real-time streaming protocol (RTSP).

### BRIEF DESCRIPTION OF THE DRAWINGS

The above and other features and advantages of the present invention will become more apparent by describing in detail exemplary embodiments thereof with reference to the attached drawings in which:

FIG. 1 is a view for explaining a conventional home network environment according to the definition by the DHWG;

FIG. 2 is a diagram of a conventional system configuration composed of a control point, a source device, and a sink device;

FIG. 3 is a diagram illustrating a conventional HTTP message structure;

FIG. 4 is a diagram of a system configuration composed of a control point, a source device, and a sink device according to an exemplary embodiment of the present invention;

FIG. 5 is an outlined block diagram of a configuration of a source device according to an exemplary embodiment of the present invention;

FIG. 6 is an outlined block diagram of a configuration of a sink device according to an exemplary embodiment of the present invention;

FIG. 7 is a message flowchart according to an exemplary embodiment of the present invention; and

FIG. 8 is diagram illustrating an example of an HTTP control command for controlling an RTP according to an exemplary embodiment of the present invention.

FIG. 9 is a diagram illustrating an example of an HTTP control command embodied in an HTTP POST command according to an exemplary embodiment of the present invention.

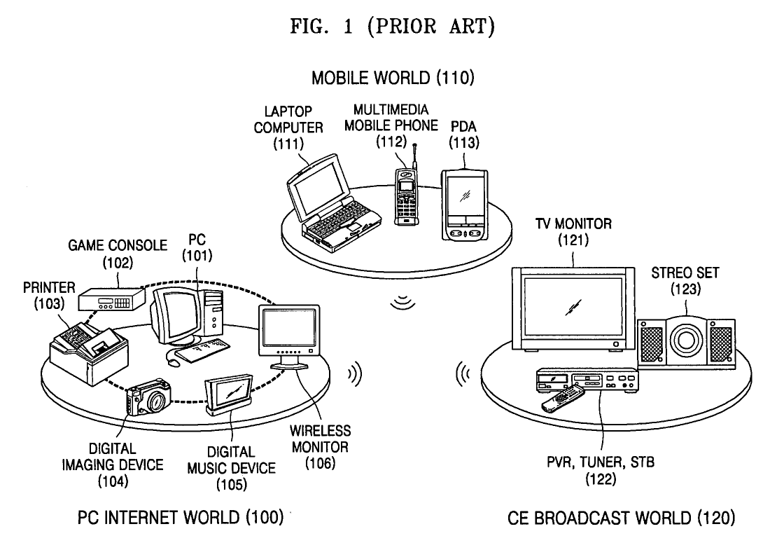

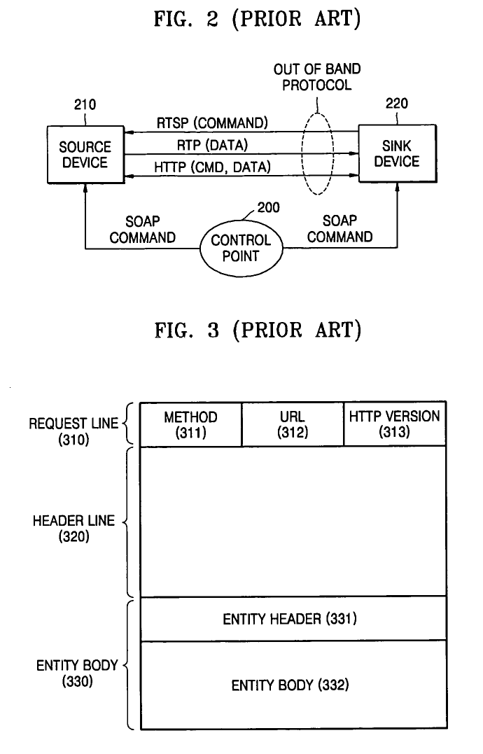

### DETAILED DESCRIPTION OF EXEMPLARY EMBODIMENTS OF THE INVENTION

The present invention will now be described more fully with reference to the accompanying drawings, in which exemplary embodiments of the invention are shown. Throughout the drawings, like reference numerals are used to refer to like elements.

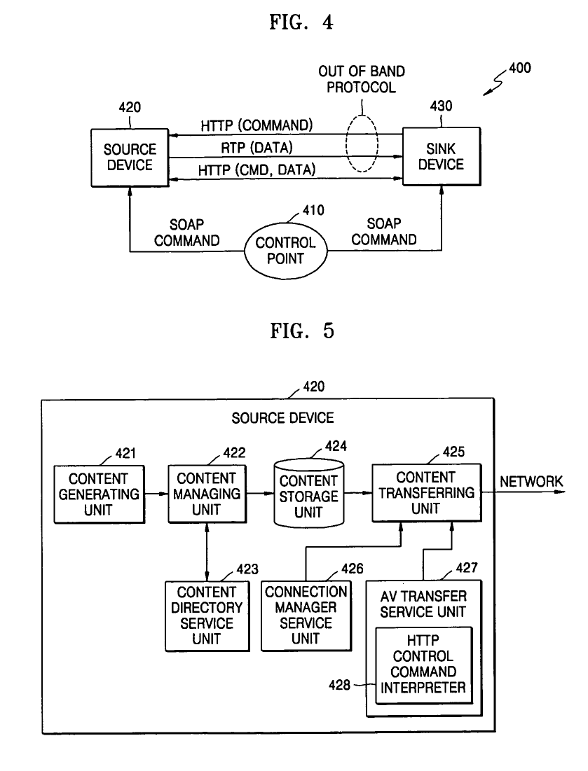

FIG. 4 is a diagram showing a configuration of a universal plug and play (UPnP) system in accordance with an exemplary embodiment of the present invention.

Referring to FIG. 4, the UPnP system 400 includes a control point 410, a source device 420, and a sink device 430.

The control point 410 controls the source device 420 and the sink device 430 and detects states thereof, using a simple object access protocol (SOAP) command.

The source device 420 receives commands from the control point 410 and provides necessary information to the control point, and receives commands from the sink device 430 and provides audio/video (AV) content. Particularly, under the present invention, the source device 420 receives a hypertext transfer protocol (HTTP) command from the sink device 430 and transfers AV content to the sink device 430 over an RTP.

The sink device 430 as a device to consume content, that is, a device to do rendering, performs necessary operations by receiving commands from the control point 410. In particular, according to an exemplary embodiment of the present invention, the sink device 430 uses an HTTP command when sending a control command for receiving AV content from the source device 420 over a real-time transport protocol (RTP). That is, when receiving a play command from the control point 410, the sink device 430 sends the play command to the source device 420 using HTTP, and receives the AV content transferred from the source device 420 over an RTP and performs rendering.

FIG. 5 is an outlined block diagram illustrating a configuration of the source device according to an exemplary embodiment of the present invention.

Referring to FIG. 5, the source device 420 includes a content generating unit 421, a content managing unit 422, a content directory service unit 423, a content storage unit 424, a content transferring unit 425, and connection manager service unit 426.

The content generating unit 421 generates AV content by capture, and so on.

The content managing unit 422 manages content generated by the content generating unit 421.

The content storage unit 424 is a database to store the content to be managed.

The content transferring unit 425 transfers content stored in the content storage unit 424 to the sink device over a network.

The content directory service unit 423 provides a service to enumerate available content such as videos, music, pictures, and so on. Browse is included in this service, as an important action. The Browse allows the control point to obtain detailed information of each content which a source device can provide. The detailed information of content includes transport protocol information and data format information, and so on which are supported by specific content.

The connection manager service unit 426 determines how content can be transferred to media renderer devices from a media server.

An AV transfer service unit 427 controls flow of content, such as play, stop, pause, seek and so on. In particular, according to an exemplary embodiment of the present invention, the AV transfer service unit 427 includes an HTTP control command interpreter 428 to interpret an HTTP control command received from the sink device. According to an exemplary embodiment of the present invention, the HTTP control command is a control command using an HTTP POST or HTTP PUT, and a request that the sink device receives content by using an RTP. The HTTP control command interpreter 428 receives and interprets the HTTP control command according to an exemplary embodiment of the present invention. Based on the interpreted results, the AV transfer service unit 427 controls content to be transferred to the sink device by using an RTP.

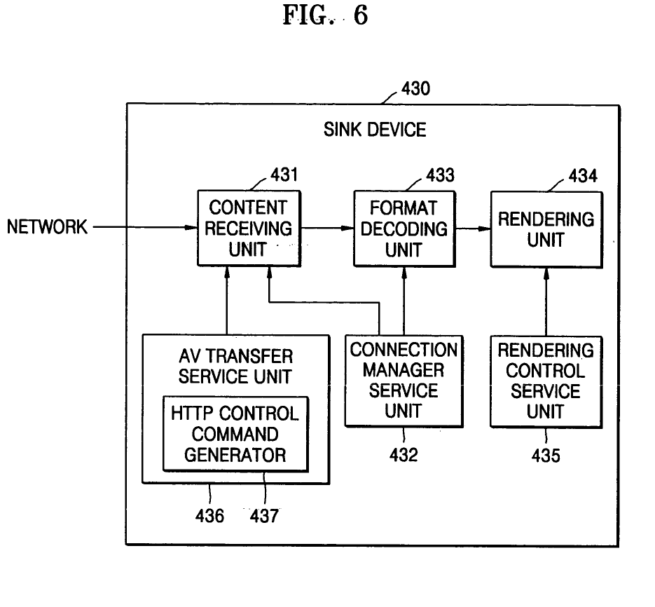

FIG. 6 is an outlined block diagram of a sink device configuration according to an exemplary embodiment of the present invention.

Referring to FIG. 6, the sink device 430 includes a content receiving unit 431, connection manager service unit 432, a format decoding unit 433, a rendering unit 434, and a rendering control service unit 435.

The content receiving unit 431 receives content from a source device over a network.

The format decoding unit 433 decodes the format of the content received by the content receiving unit 431.

The rendering unit 434 performs rendering of data decoded by the format decoding unit 433.

The connection manager service unit 432 manages the connection in association with devices.

The rendering control service unit 435 controls how content will be played back. Rendering features, such as volume, contrast, and brightness, may be included.

An AV transfer service unit 436 controls the flow of content, such as play, stop, pause, seek, and so on. In particular, according to an exemplary embodiment of the present invention, the AV transfer service unit 436 includes an HTTP control command generator 437 for generating an HTTP control command that instructs the source device to perform an operation when the operation command of content is received from the control point. The HTTP control command generator 437 generates an HTTP control command using an HTTP POST or an HTTP PUT, and then the AV transfer service unit 436 controls the generated HTTP control command to be transferred to the source device.

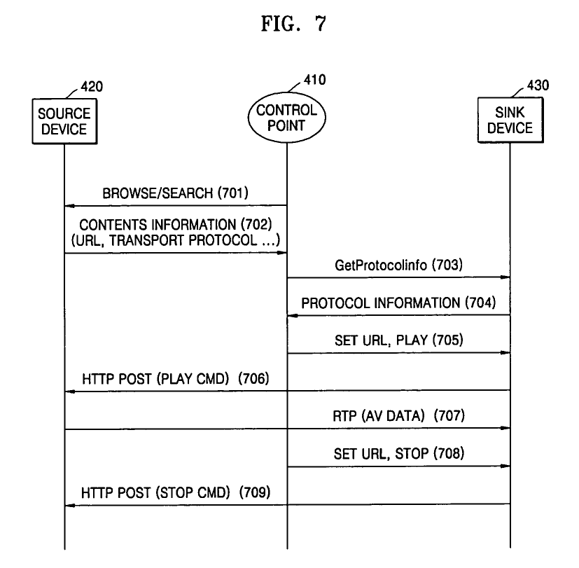

FIG. 7 is a flowchart of messages for controlling content over a network according to an exemplary embodiment of the present invention.

The control point 410 executes a browse or search command for fetching the information of the content from the source device 420 (Operation 701) to obtain various information about content from the source device 420, especially, the URL of the content and the transport protocol information including information about the transport mode (Operation 702).

Thereafter, the control point 410 transmits a Getprotocolinfo command to the sink device 430 (Operation 703) to obtain the transport protocol information that the sink device can support (Operation 704). The control point 410 receives the transport protocol information from the sink device and determines which transport protocol is identical to the transport protocol used by the source device 420.

Next, the control point 410 provides the sink device 430 with protocol information and a content URL to be sent together with a play command to play the content (Operation 705).

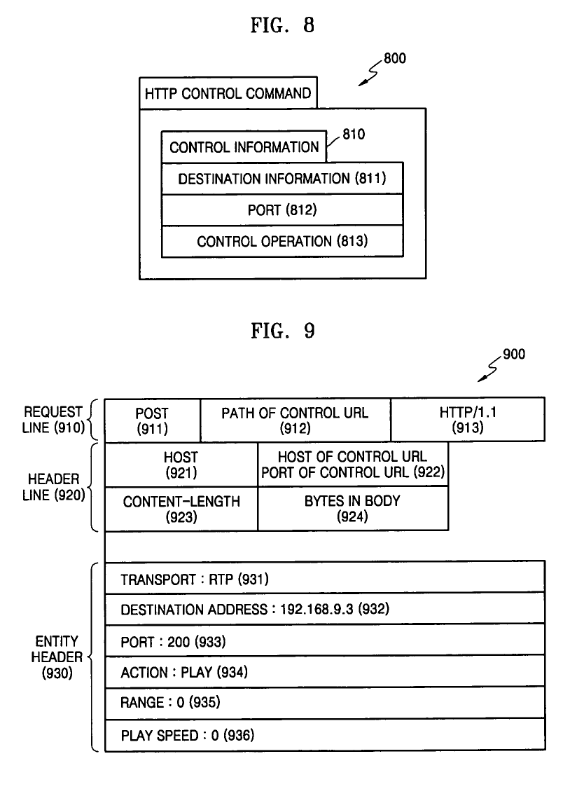

If the protocol to be sent is HTTP, the sink device 430 gets an AV content from the source device 420 using an HTTP GET method, and if the transport protocol is an RTP, the sink device 430 creates a control command using an HTTP POST or an HTTP PUT command and transfers the HTTP control command to the source device 420 (Operation 706). Referring to FIGS. 8 and 9, the HTTP control command according to an exemplary embodiment of the present invention will be described below more particularly.

The source device 420 receiving the control command sends the content specified by the control command to the sink device 430 using an RTP (Operation 707). The sink device 430 receives and handles the content transferred over the RTP port.

In order to stop the content from playing back, the control point 410 provides the sink device 430 with protocol information and a content URL to be sent together with a stop command (Operation 708).

The sink device 430 sends a playback stop control command to the source device 420 by using an HTTP control command, for example, an HTTP POST command (Operation 709).

In operations illustrated in FIG. 7, the control point can be mounted in the source device or sink device as one device, and in such case the interaction between the control point and each device can be omitted.

FIG. 8 illustrates an HTTP control command for controlling an RTP according to an exemplary embodiment of the present invention.

Referring to FIG. 8, the HTTP control command 800 contains control information 810 for controlling content. The content control information 810 includes destination information 811, a port 812 and a control operation 813.

The HTTP control command can be created using an HTTP PUT command or an HTTP POST command. The content control information 810 can be contained in a header or entity body of an HTTP message.

The destination information 811 indicates an address of the sink device, and the source device sends content to this destination address when transferring content to the source device. In case the destination address information is omitted from the control information, the content can be sent to an IP address to which the HTTP control command has been transferred.

The port 812 may be provided from the control point or be a value which is designated by the sink device.

It is possible to manage the state of a URL using the corresponding destination EP address and the port, and to provide session information by using, when necessary, other header field.

The control operation 813 indicates an operation of controlling content. For example, when stopping an operation or performing a trick play operation, a command is sent to the sink device from the control point, and then the sink device receiving the command can transfer a stop command or a trick play command to the source device by using such control operation information.

FIG. 9 illustrates an example of the HTTP control command embodied in an HTTP POST command according to an exemplary embodiment of the present invention.

Referring to FIG. 9, the HTTP POST control command 900 includes a request line 910, a header line 920 and an entity header 930.

The request line 910 includes a POST 911 as a method, a path of control URL 912, and HTTP/1.1 913 as an HTTP version.

The header line 920 includes a HOST 921 as a header field name, a host of control URL and a port of control URL 922 as a value of the HOST 921, a CONTENT-LENGTH 923 as a size of content, and bytes in body 924 as a value of the CONTENT-LENGTH 923.

The HOST 921 indicates an Internet host and port number of a resource to be requested, and a value of the HOST 921 is included in the port of control URL 922.

The CONTENT-LENGTH 923 indicates a size of an entity body, and a value of the CONTENT-LENGTH 923 is included in the bytes in body 924.

The entity header 930 is composed of a transport: RTP 931, a DESTINATION ADDRESS: 192.168.9.3 932, a PORT: 200 933, an ACTION: Play 934, a RANGE: 0 935, and a PLAY SPEED: 0 936.

The transport 931 indicates a transport protocol through which content will be transferred.

The destination address 932 and the port 933 are addresses to which content will be provided.

The action 934 is a control operation, and can include stop, pause, fast forward (FF), fast rewind (FR) and seek, in addition to play.

The range 935 denotes a range of playback time. The PLAY SPEED 936 indicates a speed at which content is played back.

The message structure illustrated in FIG. 9 is just an example, therefore, control information included in the entity header may be put into the entity body depending on the exemplary embodiment shown in FIG. 9, and also the form of the control information to be put into the entity body can be changed depending on another exemplary embodiment.

As described above, according to an exemplary embodiment of the present invention, when transferring AV content over an RTP, the content is controlled using an existing HTTP not a real-time streaming protocol (RTSP), and thus, the RTP can be more easily supported. This can be an effective content control method when using an RTP in the Digital Home Working Group (DHWG).

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A method of controlling content over a network, the method comprising:
transferring a hypertext transfer protocol (HTTP) control command made so that content is provided from a media server using a real-time transport protocol (RTP); and
receiving the content from the media server using the RTP.

2. The method of claim 1, wherein the HTTP control command comprises one of an HTTP POST command and an HTTP PUT command.

3. The method of claim 1, wherein the HTTP control command comprises information about content transport.

4. The method of claim 3, wherein the content transport information comprises destination address information and port information for receiving the content.

5. The method of claim 4, wherein the content transport information provides destination information and port information for receiving content as information for managing a session.

6. The method of claim 1, wherein the HTTP control command comprises control operation information with respect to the content.

7. A method of controlling content over a network, the method comprising:
receiving a hypertext transfer protocol (HTTP) control command so that content is provided, from a media renderer performing rendering of the content over a network; and
sending the content over a network by using a real-time transport protocol (RTP) in response to the receipt of the HTTP control command.

8. The method of claim 7, wherein the HTTP control command comprises one of HTTP POST command and an HTTP PUT command.

9. The method of claim 7, wherein the HTTP control command comprises information about content transport.

10. The method of claim 9, wherein the content transport information comprises destination address information and port information for sending content, and in the operation of sending the content, the content is sent to a destination indicated by the destination address information and the port information.

11. The method of claim 7, further comprising controlling the content based on control operation information, wherein the HTTP control command comprises the control operation information with respect to the content.

12. A media renderer device for controlling content over a network, the media renderer device comprising a hypertext transfer protocol (HTTP) control command generating unit generating an HTTP control command by which content is provided from a media server providing content using a Real-Time Transport Protocol (RTP).

13. The device of claim 12, wherein the HTTP control command generating unit generates the HTTP control command by using one of an HTTP POST command and an HTTP PUT command.

14. The device of claim 12, wherein the HTTP control command comprises information about content transport.

15. The device of claim 12, wherein the content transport information comprises destination address information and port information related to receiving the content.

16. The device of claim 12, wherein the HTTP control command comprises control operation information with respect to the content.

17. A media server device for controlling content over a network, the media server device comprising:
a hypertext transfer protocol (HTTP) control command interpreter interpreting an HTTP control command generated so that content is provided to a media renderer performing rendering of content, over a network using real-time transport protocol (RTP); and
a content transferring unit transferring the content over a network using the RTP based on an interpreted result.

18. The device of claim 17, wherein the HTTP control command comprises one of an HTTP POST command and an HTTP PUT command.

19. The device of claim 17, wherein the HTTP control command comprises information related to content transport.

20. The device of claim 19, wherein the content transport information comprises destination address information and port information for transferring the content, and the content transferring unit transfers the content to a destination indicated according to the destination address information and the port information.

21. The device of claim 17, wherein the HTTP control command comprises control operation information related to the content, and the HTTP control command interpreter controls the content based on the control operation information.

22. A message for controlling a Real-time Transport Protocol (RTP) of content on a network, in which the message is based on an HTTP request message, the message comprising:
transport protocol information for transferring content;
address information related to receiving the content; and
operation control information related to the content.

23. The message of claim 22, wherein the HTTP request message uses one of an HTTP POST message and an HTTP PUT message.
